(19) United States
(12) Patent Application Publication
(10) Pub. No.: US 2018/0183488 A1
(43) Pub. Date: Jun. 28, 2018

(54) METHOD FOR INDICATING SYNCHRONIZATION SIGNAL PERIOD AND APPARATUS

(71) Applicant: HUAWEI TECHNOLOGIES CO., LTD., Shenzhen (CN)

(72) Inventors: Bingyu QU, Beijing (CN); Chuanfeng HE, Shenzhen (CN)

(21) Appl. No.: 15/902,699

(22) Filed: Feb. 22, 2018

Related U.S. Application Data
(63) Continuation of application No. PCT/CN2015/088282, filed on Aug. 27, 2015.

(51) Int. Cl. H04B 1/7087; H04W 56/00; H04L 1/00

(52) U.S. Cl. CPC H04B 1/7087; H04L 1/0041; H04W 56/00

(57) ABSTRACT

A method for indicating a synchronization signal period and an apparatus are provided. In one example, a base station indicates a synchronization signal period to a terminal, and after determining the synchronization signal period, the terminal receives a synchronization signal of a corresponding beam according to the synchronization signal period.

### CROSS-REFERENCE TO RELATED APPLICATIONS

This application is a continuation of International Application No. PCT/CN2015/088282, filed on Aug. 27, 2015, the disclosure of which is hereby incorporated by reference in its entirety.

### TECHNICAL FIELD

The present invention relates to the field of communications technologies, and in particular, to a method for indicating a synchronization signal period and an apparatus.

### BACKGROUND

In a low frequency scenario, a beam formed at each antenna port is a wide beam shown in FIG. 1A, and can cover users in an entire cell because a path loss of a radio signal is relatively small in the scenario.

However, in a high frequency scenario, a path loss of a radio signal increases. If the signal is still transmitted by using a wide beam, because coverage of a cell is small, the wide beam cannot cover a terminal at a relatively long distance. As shown in FIG. 1B, the wide beam cannot cover a terminal 1 and a terminal 2. In the high frequency scenario, a distance between antennas may decrease. Therefore, a quantity of antennas that can be accommodated per unit area increases. To enable the terminal at the relatively long distance to receive the radio signal, a massive Multiple-Input Multiple-Output (MIMO) beamforming technology may be used to obtain a high antenna gain to compensate for the path loss, as shown in FIG. 1C.

A base station using the massive MIMO technology includes many or even hundreds of antennas. A width of a formed beam is narrow when a high antenna gain is obtained. One narrow beam only covers a part of a region, and cannot cover all users in a cell. For example, in FIG. 1C, a beam B2 can cover only a terminal 1 and cannot cover a terminal 2.

In the high frequency scenario using the massive MIMO technology, a terminal is mobile, and different beams may need to serve a cell by means of time division. Synchronization signals need to be broadcast by using the beams, so that terminals in a cell can access the cell according to the synchronization signals.

A synchronization signal in an existing Long Term Evolution (LTE) system includes a Primary Synchronization Signal (PSS) and an Secondary Synchronous Signal (SSS). FIG. 1D is a schematic diagram in which a synchronization signal is carried in a radio frame. In the LTE system, a base station periodically transmits a synchronization signal. A terminal detects the synchronization signal, implements initial synchronization and obtains a physical cell identifier according to the detected synchronization signal, and then accesses a cell.

In the high frequency scenario, a terminal accesses a cell mainly in single-loop and dual-loop manners. Because the dual-loop access manner has disadvantages such as relatively low overheads, relatively little interference, and low energy consumption of a base station, the dual-loop access advantages is currently a main manner for accessing a cell by a terminal.

A main idea of dual-loop access is: A base station periodically performs beam scanning in a first loop. A terminal detects synchronization signals for all beams, and feeds back corresponding beam identifiers to the base station. The base station determines an effective beam according to the received beam identifiers, and then transmits a synchronization signal for the effective beam in a second loop. As shown in FIG. 1E, assuming that after beam scanning in the first loop, the terminal feeds back beam identifiers corresponding to B0 to B3, and the base station determines that B0 to B3 are effective beams, the base station periodically transmits synchronization signals for B0 to B3 in the second loop.

However, because the terminal does not know a period of a synchronization signal that is periodically sent by the base station for an effective beam and that is detected by the terminal, the terminal needs to continuously perform blind detection for the synchronization signal for the effective beam, leading to disadvantages of poor synchronization performance and relatively high power consumption.

### SUMMARY

Embodiments of the present invention provide a method for indicating a synchronization signal period and an apparatus, so as to avoid disadvantages of poor synchronization performance and relatively high power consumption in a process of accessing a cell by a terminal in the prior art.

According to a first aspect, a method for indicating a synchronization signal period is provided, including:

determining, by a base station, a synchronization signal period; and

indicating, by the base station, the synchronization signal period.

With reference to the first aspect, in a first possible implementation, before the indicating, by the base station, the synchronization signal period, the method further includes:

transmitting, by the base station, a synchronization signal; and

the indicating, by the base station, the synchronization signal period includes:

indicating, by the base station, the synchronization signal period by using the synchronization signal.

With reference to the first possible implementation of the first aspect, in a second possible implementation, the transmitting, by the base station, a synchronization signal includes:

determining, by the base station, a synchronization signal sequence corresponding to the synchronization signal period, and transmitting a synchronization signal that uses the synchronization signal sequence.

With reference to the first or the second possible implementation of the first aspect, in a third possible implementation, before the indicating, by the base station, the synchronization signal period, the method further includes:

transmitting, by the base station, a physical channel corresponding to the synchronization signal; and

the indicating, by the base station, the synchronization signal period includes:

indicating, by the base station, the synchronization signal period by using the physical channel corresponding to the synchronization signal.

With reference to the third possible implementation of the first aspect, in a fourth possible implementation, the indicating, by the base station, the synchronization signal period by using the physical channel corresponding to the synchronization signal includes:

adding, by the base station, information including the synchronization signal period to the physical channel, to indicate the synchronization signal period; or

determining, by the base station according to a specified correspondence between a synchronization signal period and a scrambling code, a scrambling code corresponding to the synchronization signal period that is to be indicated, and scrambling the physical channel by using the determined scrambling code, to indicate the synchronization signal period; or

determining, by the base station according to a specified correspondence between a synchronization signal period and a mask, a mask corresponding to the synchronization signal period that is to be indicated, and masking a cyclic redundancy check (CRC) corresponding to the physical channel by using the mask, to indicate the synchronization signal period; or

determining, by the base station according to a specified correspondence between a synchronization signal period and a CRC computation mode, a CRC computation mode corresponding to the synchronization signal period that is to be indicated, performing CRC computation on initial information in the determined CRC computation mode to obtain a CRC value, and transmitting the initial information and the calculated CRC value on the physical channel, to indicate the synchronization signal period; or

determining, by the base station according to a specified correspondence between a synchronization signal period and a time-frequency resource location, a time-frequency resource location corresponding to the synchronization signal period that is to be indicated, and adding the physical channel to the determined time-frequency resource location, to indicate the synchronization signal period.

According to a second aspect, a method for indicating a synchronization signal period is provided, including:

detecting, by a terminal, a synchronization signal; and

determining, by the terminal, a synchronization signal period by using the detected synchronization signal.

With reference to the second aspect, in a first possible implementation, the determining, by the terminal, a synchronization signal period by using the detected synchronization signal includes:

determining, by the terminal, a synchronization signal sequence used for the detected synchronization signal; and

determining, by the terminal, a synchronization signal period corresponding to the synchronization signal sequence.

With reference to the second aspect, in a second possible implementation, before the determining, by the terminal, a synchronization signal period by using the detected synchronization signal, the method further includes:

determining, by the terminal, a physical channel corresponding to the synchronization signal; and

the determining, by the terminal, a synchronization signal period by using the detected synchronization signal includes:

determining, by the terminal, the synchronization signal period by using the physical channel.

With reference to the second possible implementation of the second aspect, in a third possible implementation, the determining, by the terminal, the synchronization signal period by using the physical channel includes:

determining, by the terminal, information that includes the synchronization signal period and that is carried on the physical channel, and determining the synchronization signal period in the information; or

determining, by the terminal, a scrambling code for scrambling the physical channel, searching a specified correspondence between a synchronization signal period and a scrambling code for a synchronization signal period corresponding to the scrambling code, and using the found synchronization signal period as the determined synchronization signal period; or

determining, by the terminal, a mask for masking a cyclic redundancy check (CRC) corresponding to the physical channel, searching a specified correspondence between a synchronization signal period and a mask for a synchronization signal period corresponding to the mask, and using the found synchronization signal period as the determined synchronization signal period; or

receiving, by the terminal, initial information and a CRC value on the physical channel, performing CRC computation on the initial information in all stored CRC computation modes to obtain corresponding CRC values, using a CRC value that is in the calculated CRC values and that is the same as the received CRC value as a target CRC value, using a CRC computation mode corresponding to the target CRC value as a target CRC computation mode, searching a specified correspondence between a synchronization signal period and a CRC computation mode for a synchronization signal period corresponding to the target CRC computation mode, and using the found synchronization signal period as the determined synchronization signal period; or

determining, by the terminal, a time-frequency resource location at which the physical channel is carried, searching a specified correspondence between a synchronization signal period and a time-frequency resource location for a synchronization signal period corresponding to the time-frequency resource location at which the physical channel is carried, and using the found synchronization signal period as the determined synchronization signal period.

According to a third aspect, a base station is provided, including:

a determining unit, configured to determine a synchronization signal period; and

an indication unit, configured to indicate the synchronization signal period.

With reference to the third aspect, in a first possible implementation, the base station further includes a transmitting unit, configured to transmit a synchronization signal; and

when indicating the synchronization signal period, the indication unit is specifically configured to:

indicate the synchronization signal period by using the synchronization signal.

With reference to the first possible implementation of the third aspect, in a second possible implementation, the determining unit is further configured to determine a synchronization signal sequence corresponding to the synchronization signal period; and

when transmitting the synchronization signal, the transmitting unit is specifically configured to:

transmit a synchronization signal that uses the synchronization signal sequence.

With reference to the first or the second possible implementation of the third aspect, in a third possible implementation, the transmitting unit is further configured to transmit a physical channel corresponding to the synchronization signal; and

when indicating the synchronization signal period, the indication unit is specifically configured to:

indicate the synchronization signal period by using the physical channel corresponding to the synchronization signal.

With reference to the third possible implementation of the third aspect, in a fourth possible implementation, when indicating the synchronization signal period by using the physical channel corresponding to the synchronization signal, the indication unit is specifically configured to:

add information including the synchronization signal period to the physical channel, to indicate the synchronization signal period; or

determine, according to a specified correspondence between a synchronization signal period and a scrambling code, a scrambling code corresponding to the synchronization signal period that is to be indicated, and scramble the physical channel by using the determined scrambling code, to indicate the synchronization signal period; or

determine, according to a specified correspondence between a synchronization signal period and a mask, a mask corresponding to the synchronization signal period that is to be indicated, and mask a cyclic redundancy check (CRC) corresponding to the physical channel by using the mask, to indicate the synchronization signal period; or

determine, according to a specified correspondence between a synchronization signal period and a CRC computation mode, a CRC computation mode corresponding to the synchronization signal period that is to be indicated, perform CRC computation on initial information in the determined CRC computation mode to obtain a CRC value, and transmit the initial information and the calculated CRC value on the physical channel, to indicate the synchronization signal period; or

determine, according to a specified correspondence between a synchronization signal period and a time-frequency resource location, a time-frequency resource location corresponding to the synchronization signal period that is to be indicated, and add the physical channel to the determined time-frequency resource location, to indicate the synchronization signal period.

According to a fourth aspect, a terminal is provided, including:

a receiving unit, configured to detect a synchronization signal; and

a determining unit, configured to determine a synchronization signal period by using the detected synchronization signal.

With reference to the fourth aspect, in a first possible implementation, when determining the synchronization signal period by using the detected synchronization signal, the determining unit is specifically configured to:

determine a synchronization signal sequence used for the detected synchronization signal; and

determine a synchronization signal period corresponding to the synchronization signal sequence.

With reference to the fourth aspect, in a second possible implementation, the determining unit is further configured to determine a physical channel corresponding to the synchronization signal; and

when determining the synchronization signal period by using the detected synchronization signal, the determining unit is specifically configured to:

determine the synchronization signal period by using the physical channel.

With reference to the second possible implementation of the fourth aspect, in a third possible implementation, when determining the synchronization signal period by using the physical channel, the determining unit is specifically configured to:

determine information that includes the synchronization signal period and that is carried on the physical channel, and determine the synchronization signal period in the information; or

determine a scrambling code for scrambling the physical channel, search a specified correspondence between a synchronization signal period and a scrambling code for a synchronization signal period corresponding to the scrambling code, and use the found synchronization signal period as the determined synchronization signal period; or

determine a mask for masking a cyclic redundancy check (CRC) corresponding to the physical channel, search a specified correspondence between a synchronization signal period and a mask for a synchronization signal period corresponding to the mask, and use the found synchronization signal period as the determined synchronization signal period; or

receive initial information and a CRC value on the physical channel, perform CRC computation on the initial information in all stored CRC computation modes to obtain corresponding CRC values, use a CRC value that is in the calculated CRC values and that is the same as the received CRC value as a target CRC value, use a CRC computation mode corresponding to the target CRC value as a target CRC computation mode, search a specified correspondence between a synchronization signal period and a CRC computation mode for a synchronization signal period corresponding to the target CRC computation mode, and use the found synchronization signal period as the determined synchronization signal period; or

determine a time-frequency resource location at which the physical channel is carried, search a specified correspondence between a synchronization signal period and a time-frequency resource location for a synchronization signal period corresponding to the time-frequency resource location at which the physical channel is carried, and use the found synchronization signal period as the determined synchronization signal period.

The embodiments of the present invention provide the method for indicating a synchronization signal period. In the solutions, the base station indicates the synchronization signal period to the terminal, and after determining the synchronization signal period, the terminal receives a synchronization signal of a corresponding beam according to the synchronization signal period. No blind detection needs to be performed for the synchronization signal. Therefore, disadvantages of poor synchronization performance and relatively high power consumption in a current process of accessing a cell by the terminal are avoided.

### BRIEF DESCRIPTION OF DRAWINGS

FIG. 1A is a schematic diagram of a wide beam in a low frequency scenario in the prior art;

FIG. 1B is a schematic diagram of a wide beam in a high frequency scenario in the prior art;

FIG. 1C is a schematic diagram of a narrow beam in a high frequency scenario in the prior art;

FIG. 1D is a schematic diagram of a radio frame carrying a synchronization signal in the prior art;

FIG. 1E is a schematic diagram of transmitting a synchronization signal in a dual-loop manner in the prior art;

FIG. 2A is a flowchart of indicating a synchronization signal period according to an embodiment of the present invention;

FIG. 2B is a schematic diagram of a correspondence between a synchronization signal and a physical channel according to an embodiment of the present invention;

FIG. 3 is another flowchart of indicating a synchronization signal period according to an embodiment of the present invention;

FIG. 4A is a schematic diagram of a base station according to an embodiment of the present invention;

FIG. 4B is another schematic diagram of a base station according to an embodiment of the present invention;

FIG. 5A is a schematic diagram of a terminal according to an embodiment of the present invention; and

FIG. 5B is another schematic diagram of a terminal according to an embodiment of the present invention.

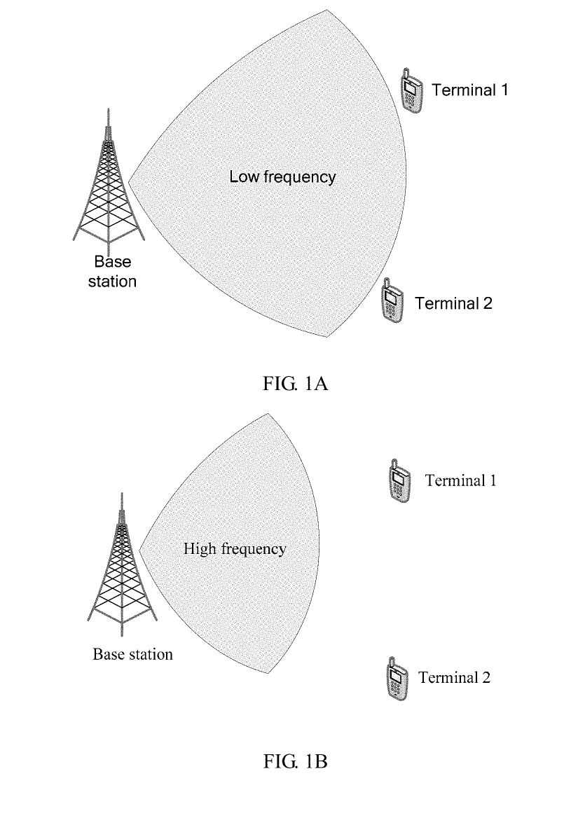

### DESCRIPTION OF EMBODIMENTS

To make the objectives, technical solutions, and advantages of the present invention clearer, the following further describes the present invention in detail with reference to the accompanying drawings. Apparently, the described embodiments are merely some rather than all of the embodiments of the present invention. All other embodiments obtained by persons of ordinary skill in the art based on the embodiments of the present invention without creative efforts shall fall within the protection scope of the present invention.

In addition, the terms “system” and “network” may be used interchangeably in this specification. The term “and/or” in this specification describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects.

In the following, implementations of the present invention are described in detail with reference to the accompanying drawings. It should be understood that the embodiments described herein are merely used to illustrate and explain the present invention, but are not intended to limit the present invention. In addition, the embodiments of this application and features in the embodiments may be mutually combined in a case in which they do not conflict with each other.

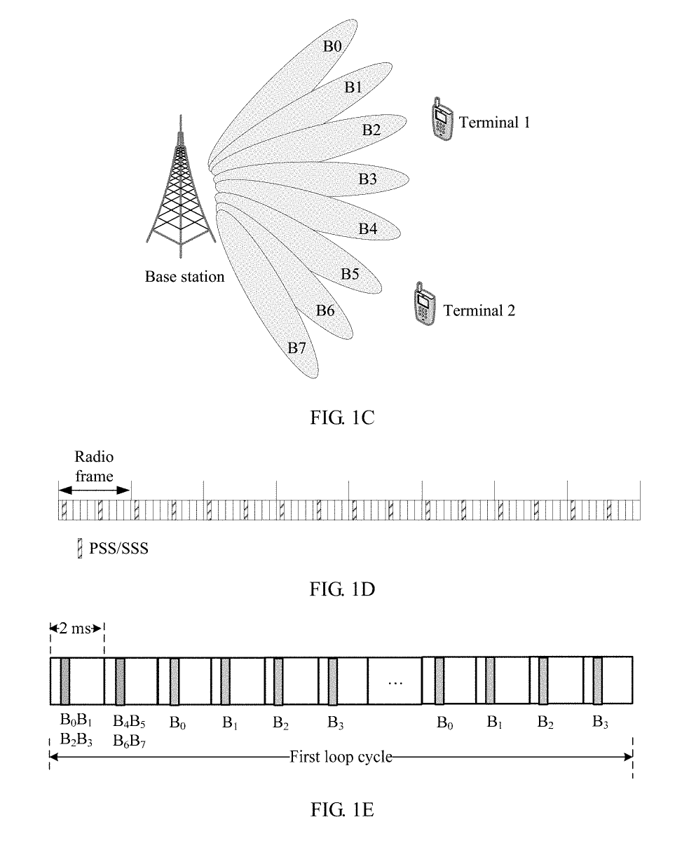

Referring to FIG. 2A, in an embodiment of the present invention, a procedure of indicating a synchronization signal period is as follows:

Step 200: A base station determines a synchronization signal period.

Step 210: The base station indicates the synchronization signal period.

In this way, after the base station indicates the synchronization signal period, the terminal detects a synchronization signal according to the synchronization signal period indicated by the base station, and the terminal knows a time interval for detecting the synchronization signal, thereby preventing the terminal from performing blind detection for the synchronization signal, and avoiding disadvantages of poor synchronization performance and relatively high power consumption in a current process of accessing a cell by the terminal.

In this embodiment of the present invention, before the base station indicates the synchronization signal period, the following operation is further included:

transmitting, by the base station, a synchronization signal.

In this embodiment of the present invention, there are multiple manners for indicating the synchronization signal period by the base station. Optionally, the following several manners may be used.

The base station indicates the synchronization signal period by using the synchronization signal.

When the base station indicates the synchronization signal period by using the synchronization signal, optionally, the following manner may be used:

determining, by the base station, a synchronization signal sequence corresponding to the synchronization signal period, and transmitting a synchronization signal that uses the synchronization signal sequence.

For example, the synchronization signal may use a synchronization signal sequence 1 and a synchronization signal sequence 2. The synchronization signal sequence 1 corresponds to a synchronization signal period 1, and the synchronization signal sequence 2 corresponds to a synchronization signal period 2. If the synchronization signal period determined by the base station is the synchronization signal period 1, the base station transmits a synchronization signal that uses the synchronization signal sequence 1.

For another example, the synchronization signal may use a synchronization signal sequence 1 and a synchronization signal sequence 2. The synchronization signal sequence 1 corresponds to a synchronization signal period 1, and the synchronization signal sequence 2 corresponds to a synchronization signal period 2. If the synchronization signal period determined by the base station is the synchronization signal period 2, the base station transmits a synchronization signal that uses the synchronization signal sequence 2.

In this embodiment of the present invention, each synchronization signal has a corresponding physical channel. In this way, the synchronization signal period can be indicated according to a physical channel corresponding to the synchronization signal.

In this embodiment of the present invention, optionally, the physical channel may be a PBCH (Physical Broadcast Channel, physical broadcast channel), or certainly may be another physical channel. Details are not described herein.

As shown in FIG. 2B, it can be learned from FIG. 2B that a PSS0/SSS0 corresponds to a PBCH0, a PSS1/SSS1 corresponds to a PBCH1, a PSS2/SSS2 corresponds to a PBCH2, a PSS3/SSS3 corresponds to a PBCH3, and a PSS4/SSS4 corresponds to a PBCH4. In this way, the synchronization signal period can be indicated according to a physical channel corresponding to the synchronization signal.

Therefore, in this embodiment of the present invention, before the base station indicates the synchronization signal period, the following operation is further included:

transmitting, by the base station, a physical channel corresponding to the synchronization signal; and

when the base station indicates the synchronization signal period, optionally, the following manner may be used:

indicating, by the base station, the synchronization signal period by using the physical channel corresponding to the synchronization signal.

In this embodiment of the present invention, the following several manners may be used for the physical channel:

the physical channel carries information including the synchronization signal period; or

the physical channel is scrambled by using a scrambling code corresponding to the synchronization signal period; or

a CRC (Cyclic Redundancy Check, cyclic redundancy check) corresponding to the physical channel is masked by using a mask corresponding to the synchronization signal period; or

a CRC computation mode corresponding to the physical channel corresponds to the synchronization signal period; or

the physical channel is carried at a time-frequency resource location corresponding to the synchronization signal period.

That is, when the base station indicates the synchronization signal period by using the physical channel corresponding to the synchronization signal, optionally, the following manners may be used:

adding, by the base station, the information including the synchronization signal period to the physical channel, to indicate the synchronization signal period; or

determining, by the base station according to a specified correspondence between a synchronization signal period and a scrambling code, the scrambling code corresponding to the synchronization signal period that is to be indicated, and scrambling the physical channel by using the determined scrambling code, to indicate the synchronization signal period; or

determining, by the base station according to a specified correspondence between a synchronization signal period and a mask, the mask corresponding to the synchronization signal period that is to be indicated, and masking the cyclic redundancy check (CRC) corresponding to the physical channel by using the mask, to indicate the synchronization signal period; or

determining, by the base station according to a specified correspondence between a synchronization signal period and a CRC computation mode, the CRC computation mode corresponding to the synchronization signal period that is to be indicated, performing CRC computation on initial information in the determined CRC computation mode to obtain a CRC value, and transmitting the initial information and the calculated CRC value on the physical channel, to indicate the synchronization signal period; or

determining, by the base station according to a specified correspondence between a synchronization signal period and a time-frequency resource location, the time-frequency resource location corresponding to the synchronization signal period that is to be indicated, and adding the physical channel to the determined time-frequency resource location, to indicate the synchronization signal period.

For example, the physical channel may carry 14 bits of information. Information carried on four bits is used to indicate a downlink system bandwidth, a system frame number, and a Physical HARQ Indicator Channel (PHICH) configuration, and 10 bits are idle. If there are totally four synchronization signal periods, two bits need to be used to indicate the synchronization signal period. For example, two bits “01” indicate that the synchronization signal period is a first synchronization signal period, two bits “10” indicate that the synchronization signal period is a second synchronization signal period, two bits “00” indicate that the synchronization signal period is a third synchronization signal period, and two bits “11” indicate that the synchronization signal period is a fourth synchronization signal period.

For another example, the scrambling code for scrambling the physical channel includes a scrambling code 1 and a scrambling code 2. The scrambling code 1 corresponds to a synchronization signal period 1, and the scrambling code 2 corresponds to a synchronization signal period 2. If the base station determines that the synchronization signal period is the synchronization signal period 1, the base station scrambles the physical channel by using the scrambling code 1. If the base station determines that the synchronization signal period is the synchronization signal period 2, the base station scrambles the physical channel by using the scrambling code 2.

In this way, when the terminal detects the physical channel, if the terminal implements a correct CRC check by using the scrambling code 1, it is considered that the synchronization signal period is the synchronization signal period 1, or if the terminal implements a correct CRC check by using the scrambling code 2, it is considered that the synchronization signal period is the synchronization signal period 2.

For another example, the mask for masking the CRC includes a mask 1 and a mask 2. The mask 1 corresponds to a synchronization signal period 1, and the mask 2 corresponds to a synchronization signal period 2. If the base station determines that the synchronization signal period is the synchronization signal period 1, the base station masks the CRC by using the mask code 1. If the base station determines that the synchronization signal period is the synchronization signal period 2, the base station masks the CRC by using the mask 2.

In this way, when the terminal performs a CRC check, if the terminal implements a correct CRC check by using the mask 1, it is considered that the synchronization signal period is the synchronization signal period 1, or if the terminal implements a correct CRC check by using the mask 2, it is considered that the synchronization signal period is the synchronization signal period 2.

For another example, the CRC computation mode includes a CRC computation mode 1 and a CRC computation mode 2. The CRC computation mode 1 corresponds to a synchronization signal period 1, and the CRC computation mode 2 corresponds to a synchronization signal period 2. If the base station determines that the synchronization signal period is the synchronization signal period 1, the base station masks the CRC in the CRC computation mode 1. If the base station determines that the synchronization signal period is the synchronization signal period 2, the base station masks the CRC by using the mask 2.

In this way, when performing blind detection on the physical channel, the terminal performs CRC computation on received information in the CRC computation mode 1 and the CRC computation mode 2, and compares results with a received CRC. If a correct CRC check is implemented in the CRC computation mode 1, it is considered that the synchronization signal period corresponding to the physical channel is the synchronization signal period 1. If a correct CRC check is implemented in the CRC computation mode 2, it is considered that the synchronization signal period corresponding to the physical channel is the synchronization signal period 2.

In this embodiment of the present invention, optionally, the physical channel corresponding to the synchronization signal is: a physical channel sent on a same symbol that is used to transmit the synchronization signal; or a physical channel sent on a frequency-domain resource associated with the synchronization signal; or a physical channel sent by using a same beam that is used to transmit the synchronization signal; or a physical channel sent by using a scrambling code associated with the synchronization signal; or a physical channel sent by using a mask associated with the synchronization signal.

In this solution, the base station indicates the synchronization signal period to the terminal, and after determining the synchronization signal period, the terminal receives a synchronization signal of a corresponding beam according to the synchronization signal period. No blind detection needs to be performed for the synchronization signal. Therefore, disadvantages of poor synchronization performance and relatively high power consumption in a current process of accessing a cell by the terminal are avoided.

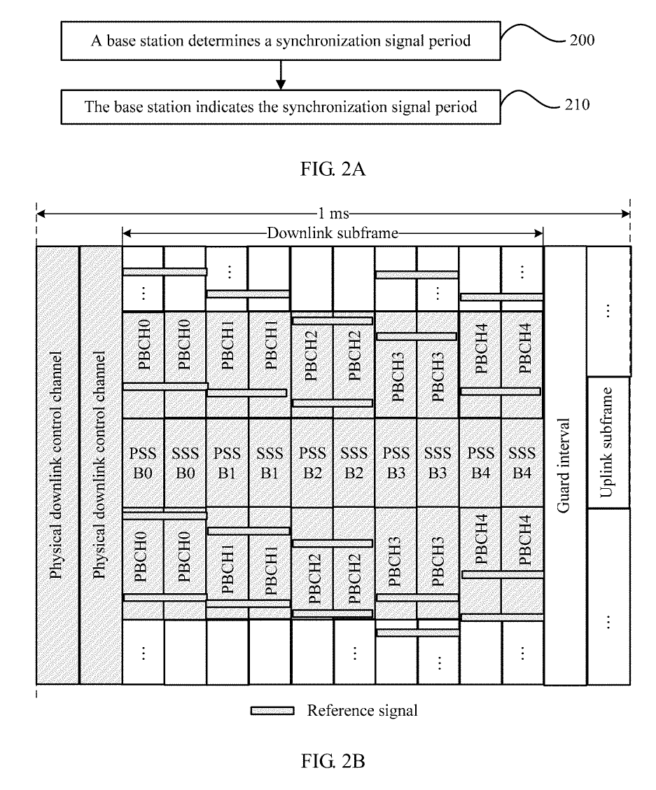

Referring to FIG. 3, in an embodiment of the present invention, a procedure of indicating a synchronization signal period is as follows:

Step 300: A terminal detects a synchronization signal.

Step 310: The terminal determines a synchronization signal period by using the detected synchronization signal.

In this way, after the terminal determines the synchronization signal period, the terminal knows a time interval for detecting the synchronization signal, thereby preventing the terminal from performing blind detection for the synchronization signal, and further avoiding disadvantages of poor synchronization performance and relatively high power consumption in a current process of accessing a cell by the terminal.

In this embodiment of the present invention, there are multiple manners for determining the synchronization signal period by the terminal by using the detected synchronization signal. Optionally, the following manner may be used:

determining, by the terminal, a synchronization signal sequence used for the detected synchronization signal; and

determining, by the terminal, a synchronization signal period corresponding to the synchronization signal sequence.

For example, the synchronization signal may use a synchronization signal sequence 1 and a synchronization signal sequence 2. The synchronization signal sequence 1 corresponds to a synchronization signal period 1, and the synchronization signal sequence 2 corresponds to a synchronization signal period 2. If the synchronization signal period detected by the terminal is the synchronization signal period 1, the terminal subsequently detects the synchronization signal by using the synchronization signal period 1.

For another example, the synchronization signal may use a synchronization signal sequence 1 and a synchronization signal sequence 2. The synchronization signal sequence 1 corresponds to a synchronization signal period 1, and the synchronization signal sequence 2 corresponds to a synchronization signal period 2. If the synchronization signal period detected by the terminal is the synchronization signal period 2, the terminal subsequently detects the synchronization signal by using the synchronization signal period 2.

According to the foregoing description, the terminal determines the synchronization signal period by using the synchronization signal sequence of the synchronization signal. During application, each synchronization signal has a corresponding physical channel. In this way, the synchronization signal period can be indicated according to a physical channel corresponding to the synchronization signal.

In this embodiment of the present invention, optionally, the physical channel may be a PBCH (Physical Broadcast Channel, physical broadcast channel), or certainly may be another physical channel. Details are not described herein. As shown in FIG. 2B, it can be learned from FIG. 2B that a PSS0/SSS0 corresponds to a PBCH0, a PSS1/SSS1 corresponds to a PBCH1, a PSS2/SSS2 corresponds to a PBCH2, a PSS3/SSS3 corresponds to a PBCH3, and a PSS4/SSS4 corresponds to a PBCH4. In this way, the synchronization signal period can be indicated according to a physical channel corresponding to the synchronization signal.

Therefore, in this embodiment of the present invention, before the terminal determines the synchronization signal period by using the detected synchronization signal, the following operation is further included:

determining, by the terminal, the physical channel corresponding to the synchronization signal.

In this case, when the terminal determines the synchronization signal period by using the detected synchronization signal, the following manner may be used:

determining, by the terminal, the synchronization signal period according to the physical channel.

That is, the terminal may determine the synchronization signal period by using the synchronization signal sequence of the synchronization signal, or may determine the synchronization signal period by using the physical channel corresponding to the synchronization signal.

When the terminal determines the synchronization signal period by using the physical channel, optionally, the following manners may be used:

determining, by the terminal, a synchronization signal period by using information that includes the synchronization signal period and that is carried on the physical channel; or

determining, by the terminal, a scrambling code for scrambling the physical channel, and determining a synchronization signal period according to the scrambling code; or

determining, by the terminal, a mask for masking a CRC corresponding to the physical channel, and determining a synchronization signal period according to the mask; or

determining, by the terminal, a CRC computation mode that corresponds to the physical channel and in which a correct CRC check is implemented, and determining a synchronization signal period according to the CRC computation mode; or

determining, by the terminal, a time-frequency resource location at which the physical channel is carried, and determining a synchronization signal period according to the time-frequency resource location.

That is, when the terminal determines the synchronization signal period by using the physical channel, optionally, the following manners may be used:

determining, by the terminal, the information that includes the synchronization signal period and that is carried on the physical channel, and determining the synchronization signal period in the information; or

determining, by the terminal, the scrambling code for scrambling the physical channel, searching a specified correspondence between a synchronization signal period and a scrambling code for the synchronization signal period corresponding to the scrambling code, and using the found synchronization signal period as the determined synchronization signal period; or

determining, by the terminal, the mask for masking the cyclic redundancy check (CRC) corresponding to the physical channel, searching a specified correspondence between a synchronization signal period and a mask for the synchronization signal period corresponding to the mask, and using the found synchronization signal period as the determined synchronization signal period; or

receiving, by the terminal, initial information and a CRC value on the physical channel, performing CRC computation on the initial information in all stored CRC computation modes to obtain corresponding CRC values, using a CRC value that is in the calculated CRC values and that is the same as the received CRC value as a target CRC value, using a CRC computation mode corresponding to the target CRC value as a target CRC computation mode, searching a specified correspondence between a synchronization signal period and a CRC computation mode for a synchronization signal period corresponding to the target CRC computation mode, and using the found synchronization signal period as the determined synchronization signal period; or

determining, by the terminal, the time-frequency resource location at which the physical channel is carried, searching a specified correspondence between a synchronization signal period and a time-frequency resource location for the synchronization signal period corresponding to the time-frequency resource location at which the physical channel is carried, and using the found synchronization signal period as the determined synchronization signal period.

For example, the physical channel may carry 14 bits of information. Information carried on four bits is used to indicate a downlink system bandwidth, a system frame number, and a PHICH configuration, and 10 bits are idle. If there are totally four synchronization signal periods, two bits need to be used to indicate the synchronization signal period. For example, two bits “01” indicate that the synchronization signal period is a first synchronization signal period, two bits “10” indicate that the synchronization signal period is a second synchronization signal period, two bits “00” indicate that the synchronization signal period is a third synchronization signal period, and two bits “11” indicate that the synchronization signal period is a fourth synchronization signal period. In this case, if “00” is carried in specified bits in the information that is carried on the physical channel and that is received by the terminal, the synchronization signal period determined by the terminal is the third synchronization signal period. If “01” is carried in specified bits in the information that is carried on the physical channel and that is received by the terminal, the synchronization signal period determined by the terminal is the first synchronization signal period.

For another example, the scrambling code for scrambling the physical channel includes a scrambling code 1 and a scrambling code 2. The scrambling code 1 corresponds to a synchronization signal period 1, and the scrambling code 2 corresponds to a synchronization signal period 2. If the terminal implements a correct CRC check by descrambling the physical channel by using the scrambling code 1, the terminal determines that the synchronization signal period is the synchronization signal period 1. If the terminal implements a correct CRC check by descrambling the physical channel by using the scrambling code 2, the terminal determines that the synchronization signal period is the synchronization signal period 2.

For another example, the mask for masking the CRC includes a mask 1 and a mask 2. The mask 1 corresponds to a synchronization signal period 1, and the mask 2 corresponds to a synchronization signal period 2. When the terminal performs a CRC check, if the terminal implements a correct CRC check by using the mask 1, it is considered that the synchronization signal period is the synchronization signal period 1, or if the terminal implements a correct CRC check by using the mask 2, it is considered that the synchronization signal period is the synchronization signal period 2.

For another example, the CRC computation mode includes a CRC computation mode 1 and a CRC computation mode 2. The CRC computation mode 1 corresponds to a synchronization signal period 1, and the CRC computation mode 2 corresponds to a synchronization signal period 2. When performing blind detection on the physical channel, the terminal performs CRC computation on received information in the CRC computation mode 1 and the CRC computation mode 2, and compares results with a received CRC. If a correct CRC check is implemented in the CRC computation mode 1, it is considered that the synchronization signal period corresponding to the physical channel is the synchronization signal period 1. If a correct CRC check is implemented in the CRC computation mode 2, it is considered that the synchronization signal period corresponding to the physical channel is the synchronization signal period 2.

In this embodiment of the present invention, optionally, the physical channel corresponding to the synchronization signal is: a physical channel sent on a same symbol that is used to transmit the synchronization signal; or a physical channel sent on a frequency-domain resource associated with the synchronization signal; or a physical channel sent by using a same beam that is used to transmit the synchronization signal; or a physical channel sent by using a scrambling code associated with the synchronization signal; or a physical channel sent by using a mask associated with the synchronization signal.

In this solution, the base station indicates the synchronization signal period to the terminal, and after determining the synchronization signal period, the terminal receives a synchronization signal of a corresponding beam according to the synchronization signal period. No blind detection needs to be performed for the synchronization signal. Therefore, disadvantages of poor synchronization performance and relatively high power consumption in a current process of accessing a cell by the terminal are avoided.

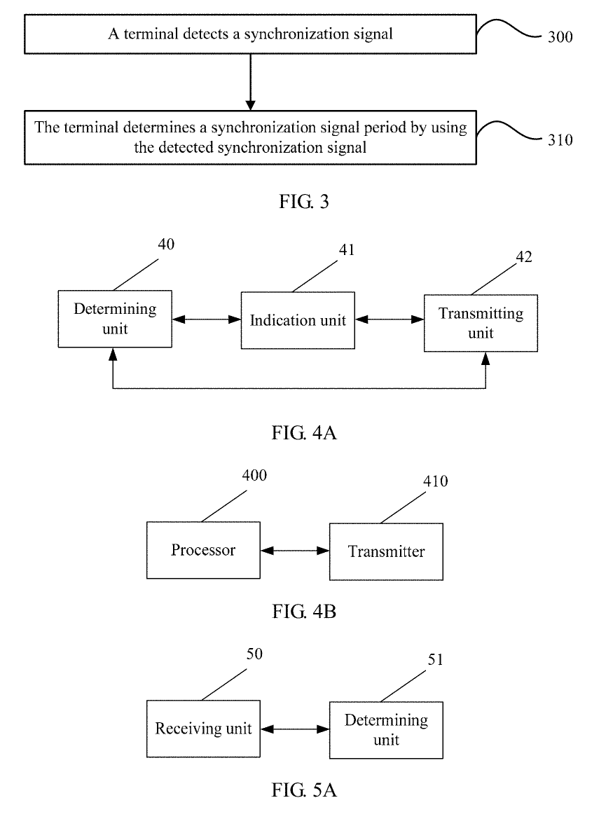

Referring to FIG. 4A, in an embodiment of the present invention, a base station is provided. The base station includes a determining unit 40 and an indication unit 41.

The determining unit 40 is configured to determine a synchronization signal period.

The indication unit 41 is configured to indicate the synchronization signal period.

Further, the base station further includes a transmitting unit 42, configured to transmit a synchronization signal.

When indicating the synchronization signal period, the indication unit 41 is specifically configured to:

indicate the synchronization signal period by using the synchronization signal.

Further, the determining unit 40 is further configured to determine a synchronization signal sequence corresponding to the synchronization signal period.

When transmitting the synchronization signal, the transmitting unit 42 is specifically configured to:

transmit a synchronization signal that uses the synchronization signal sequence.

Further, the transmitting unit 42 is further configured to transmit a physical channel corresponding to the synchronization signal.

When indicating the synchronization signal period, the indication unit 41 is specifically configured to:

indicate the synchronization signal period by using the physical channel corresponding to the synchronization signal.

Optionally, when indicating the synchronization signal period by using the physical channel corresponding to the synchronization signal, the indication unit 41 is specifically configured to:

add information including the synchronization signal period to the physical channel, to indicate the synchronization signal period; or

determine, according to a specified correspondence between a synchronization signal period and a scrambling code, a scrambling code corresponding to the synchronization signal period that is to be indicated, and scramble the physical channel by using the determined scrambling code, to indicate the synchronization signal period; or

determine, according to a specified correspondence between a synchronization signal period and a mask, a mask corresponding to the synchronization signal period that is to be indicated, and mask a cyclic redundancy check (CRC) corresponding to the physical channel by using the mask, to indicate the synchronization signal period; or

determine, according to a specified correspondence between a synchronization signal period and a CRC computation mode, a CRC computation mode corresponding to the synchronization signal period that is to be indicated, perform CRC computation on initial information in the determined CRC computation mode to obtain a CRC value, and transmit the initial information and the calculated CRC value on the physical channel, to indicate the synchronization signal period; or

determine, according to a specified correspondence between a synchronization signal period and a time-frequency resource location, a time-frequency resource location corresponding to the synchronization signal period that is to be indicated, and add the physical channel to the determined time-frequency resource location, to indicate the synchronization signal period.

Referring to FIG. 4B, this embodiment of the present invention further provides another base station. The base station includes a processor 400.

The processor 400 is configured to: determine a synchronization signal period, and indicate the synchronization signal period.

It should be noted that the processor 400 is further configured to perform other operations performed by the determining unit 40 and the indication unit 41. The base station further includes a transmitter 410. The transmitter 410 is configured to perform an operation performed by the transmitting unit 42.

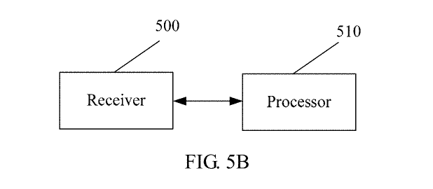

Referring to FIG. 5A, in an embodiment of the present invention, a terminal is provided. The terminal includes a receiving unit 50 and a determining unit 51.

The receiving unit 50 is configured to detect a synchronization signal.

The determining unit 51 is configured to determine a synchronization signal period by using the detected synchronization signal.

In this embodiment of the present invention, optionally, when determining the synchronization signal period by using the detected synchronization signal, the determining unit 51 is specifically configured to:

determine a synchronization signal sequence used for the detected synchronization signal; and

determine a synchronization signal period corresponding to the synchronization signal sequence.

Further, the determining unit 51 is further configured to determine a physical channel corresponding to the synchronization signal.

When determining the synchronization signal period by using the detected synchronization signal, the determining unit 51 is specifically configured to:

determine the synchronization signal period by using the physical channel.

Optionally, when determining the synchronization signal period by using the physical channel, the determining unit 51 is specifically configured to:

determine information that includes the synchronization signal period and that is carried on the physical channel, and determine the synchronization signal period in the information; or

determine a scrambling code for scrambling the physical channel, search a specified correspondence between a synchronization signal period and a scrambling code for a synchronization signal period corresponding to the scrambling code, and use the found synchronization signal period as the determined synchronization signal period; or

determine a mask for masking a cyclic redundancy check (CRC) corresponding to the physical channel, search a specified correspondence between a synchronization signal period and a mask for a synchronization signal period corresponding to the mask, and use the found synchronization signal period as the determined synchronization signal period; or

receive initial information and a CRC value on the physical channel, perform CRC computation on the initial information in all stored CRC computation modes to obtain corresponding CRC values, use a CRC value that is in the calculated CRC values and that is the same as the received CRC value as a target CRC value, use a CRC computation mode corresponding to the target CRC value as a target CRC computation mode, search a specified correspondence between a synchronization signal period and a CRC computation mode for a synchronization signal period corresponding to the target CRC computation mode, and use the found synchronization signal period as the determined synchronization signal period; or

determine a time-frequency resource location at which the physical channel is carried, search a specified correspondence between a synchronization signal period and a time-frequency resource location for a synchronization signal period corresponding to the time-frequency resource location at which the physical channel is carried, and use the found synchronization signal period as the determined synchronization signal period.

Referring to FIG. 5B, this embodiment of the present invention further provides another terminal. The terminal includes a receiver 500 and a processor 510.

The receiver 500 is configured to detect a synchronization signal.

The processor 510 is configured to determine a synchronization signal period by using the detected synchronization signal.

It should be noted that the receiver 500 is further configured to perform another operation performed by the receiving unit 50, and the processor 510 is further configured to perform another operation performed by the determining unit 51.

Persons skilled in the art should understand that the embodiments of the present invention may be provided as a method, a system, or a computer program product. Therefore, the present invention may use a form of hardware only embodiments, software only embodiments, or embodiments with a combination of software and hardware. Moreover, the present invention may use a form of a computer program product that is implemented on one or more computer-usable storage media (including but not limited to a disk memory, a CD-ROM, an optical memory, and the like) that include computer-usable program code.

The present invention is described with reference to the flowcharts and/or block diagrams of the method, the device (system), and the computer program product according to the embodiments of the present invention. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Although some embodiments of the present invention have been described, persons skilled in the art can make changes and modifications to these embodiments once they learn the basic inventive concept. Therefore, the following claims are intended to be construed as to cover the embodiments and all changes and modifications falling within the scope of the present invention.

Apparently, persons skilled in the art can make various modifications and variations to the embodiments of the present invention without departing from the spirit and scope of the embodiments of the present invention. The present invention is intended to cover these modifications and variations provided that they fall within the scope of protection defined by the following claims and their equivalent technologies.

What is claimed is:

1. A method for indicating a synchronization signal period, comprising:
determining, by a base station, the synchronization signal period;
transmitting, by the base station, a physical channel corresponding to a synchronization signal; and
indicating, by the base station, the synchronization signal period by using the physical channel.

2. The method according to claim 1, wherein the indicating, by the base station, the synchronization signal period by using the physical channel corresponding to the synchronization signal comprises:
adding, by the base station, information comprising the synchronization signal period to the physical channel, to indicate the synchronization signal period; or
determining, by the base station according to a specified correspondence between the synchronization signal period and a scrambling code, the scrambling code corresponding to the synchronization signal period that is to be indicated, and scrambling the physical channel by using the determined scrambling code, to indicate the synchronization signal period; or
determining, by the base station according to a specified correspondence between the synchronization signal period and a mask, the mask corresponding to the synchronization signal period that is to be indicated, and masking a cyclic redundancy check (CRC) corresponding to the physical channel by using the mask, to indicate the synchronization signal period; or
determining, by the base station according to a specified correspondence between the synchronization signal period and a CRC computation mode, the CRC computation mode corresponding to the synchronization signal period that is to be indicated, performing CRC computation on initial information in the determined CRC computation mode to obtain a CRC value, and transmitting the initial information and the obtained CRC value on the physical channel, to indicate the synchronization signal period; or
determining, by the base station according to a specified correspondence between the synchronization signal period and a time-frequency resource location, the time-frequency resource location corresponding to the synchronization signal period that is to be indicated, and adding the physical channel to the determined time-frequency resource location, to indicate the synchronization signal period.

3. A method for indicating a synchronization signal period, comprising:
detecting, by a terminal, a synchronization signal;
determining, by the terminal, a physical channel corresponding to the synchronization signal; and
determining, by the terminal, the synchronization signal period by using the detected synchronization signal by using the physical channel.

4. The method according to claim 3, wherein the determining, by the terminal, the synchronization signal period by using the physical channel comprises:
determining, by the terminal, information that comprises the synchronization signal period and that is carried on the physical channel, and determining the synchronization signal period in the information; or
determining, by the terminal, a scrambling code for scrambling the physical channel, searching a specified correspondence between the synchronization signal period and the scrambling code for the synchronization signal period corresponding to the scrambling code, and using the searched synchronization signal period as the determined synchronization signal period; or
determining, by the terminal, a mask for masking a cyclic redundancy check (CRC) corresponding to the physical channel, searching a specified correspondence between the synchronization signal period and the mask for a synchronization signal period corresponding to the mask, and using the searched synchronization signal period as the determined synchronization signal period; or
receiving, by the terminal, initial information and a CRC value on the physical channel, performing CRC computation on the initial information in stored CRC computation modes to obtain corresponding CRC values, using a CRC value that is in the calculated CRC values and that is the same as the received CRC value as a target CRC value, using a CRC computation mode corresponding to the target CRC value as a target CRC computation mode, searching a specified correspondence between the synchronization signal period and the target CRC computation mode for the synchronization signal period corresponding to the target CRC computation mode, and using the searched synchronization signal period as the determined synchronization signal period; or
determining, by the terminal, a time-frequency resource location at which the physical channel is carried, searching a specified correspondence between the synchronization signal period and a time-frequency resource location for a synchronization signal period corresponding to the time-frequency resource location at which the physical channel is carried, and using the searched synchronization signal period as the determined synchronization signal period.

5. A base station, comprising:
a processor; and
a non-transitory computer-readable storage medium coupled to the processor and storing programming instructions for execution by the processor, the programming instructions instruct the processor to:
determine a synchronization signal period;
a transmitter, configured to transmit a physical channel corresponding to a synchronization signal; and
wherein the programming instructions instruct the processor further to:
indicate the synchronization signal period by using the physical channel corresponding to the synchronization signal.

6. The base station according to claim 5, wherein the programming instructions instruct the processor further to:
add information comprising the synchronization signal period to the physical channel, to indicate the synchronization signal period; or
determine, according to a specified correspondence between the synchronization signal period and a scrambling code, the scrambling code corresponding to the synchronization signal period that is to be indicated, and scramble the physical channel by using the determined scrambling code, to indicate the synchronization signal period; or
determine, according to a specified correspondence between the synchronization signal period and a mask, the mask corresponding to the synchronization signal period that is to be indicated, and mask a cyclic redundancy check (CRC) corresponding to the physical channel by using the mask, to indicate the synchronization signal period; or
determine, according to a specified correspondence between the synchronization signal period and a CRC computation mode, the CRC computation mode corresponding to the synchronization signal period that is to be indicated, perform CRC computation on initial information in the determined CRC computation mode to obtain a CRC value, and transmit the initial information and the obtained CRC value on the physical channel, to indicate the synchronization signal period; or
determine, according to a specified correspondence between the synchronization signal period and a time-frequency resource location, the time-frequency resource location corresponding to the synchronization signal period that is to be indicated, and add the physical channel to the determined time-frequency resource location, to indicate the synchronization signal period.

7. A terminal, comprising:
a receiver, configured to detect a synchronization signal;
a processor; and
a non-transitory computer-readable storage medium coupled to the processor and storing programming instructions for execution by the processor, the programming instructions instruct the processor to:
determine a physical channel corresponding to the synchronization signal; and
determine a synchronization signal period by using the detected synchronization signal.

8. The terminal according to claim 7, wherein the programming instructions instruct the processor further to:
determine information that comprises the synchronization signal period and that is carried on the physical channel, and determine the synchronization signal period in the information; or
determine a scrambling code for scrambling the physical channel, search a specified correspondence between the synchronization signal period and the scrambling code for the synchronization signal period corresponding to the scrambling code, and use the searched synchronization signal period as the determined synchronization signal period; or
determine a mask for masking a cyclic redundancy check (CRC) corresponding to the physical channel, search a specified correspondence between the synchronization signal period and a mask for the synchronization signal period corresponding to the mask, and use the searched synchronization signal period as the determined synchronization signal period; or
receive initial information and a CRC value on the physical channel, perform CRC computation on the initial information in stored CRC computation modes to obtain corresponding CRC values, use a CRC value that is in the calculated CRC values and that is the same as the received CRC value as a target CRC value, use a CRC computation mode corresponding to the target CRC value as a target CRC computation mode, search a specified correspondence between the synchronization signal period and the target CRC computation mode for the synchronization signal period corresponding to the target CRC computation mode, and use the searched synchronization signal period as the determined synchronization signal period; or
determine a time-frequency resource location at which the physical channel is carried, search a specified correspondence between the synchronization signal period and a time-frequency resource location for a synchronization signal period corresponding to the time-frequency resource location at which the physical channel is carried, and use the searched synchronization signal period as the determined synchronization signal period.
